(19) United States
(12) Patent Application Publication
(10) Pub. No.: US 2023/0367009 A1
(43) Pub. Date: Nov. 16, 2023

(54) DISTANCE MEASUREMENT USING FIELD OF VIEW

(71) Applicant: ams Sensors Singapore Pte. Ltd., SINGAPORE (SG)

(72) Inventor: Dewight WARREN, Dallas, TX (US)

(73) Assignee: ams Sensors Singapore Pte. Ltd., SINGAPORE (SG)

(21) Appl. No.: 17/905,542

(22) PCT Filed: Dec. 17, 2021
(86) PCT No.: PCT/SG2021/050799

§ 371 Date: Sep. 2, 2022

(30) Foreign Application Priority Data
Feb. 5, 2021 (GB) 2101612.6

(51) Int. Cl. G01S 17/10; G01S 7/481; G01S 15/08; G01S 7/4865

(52) U.S. Cl. CPC G01S 17/10; G01S 7/4815; G01S 7/4816; G01S 7/4865; G01S 15/08

(57) ABSTRACT

An optical sensor. The optical sensor comprises a light source, first and second light sensors, and a controller. The light source has a field of illumination. The first and second light sensors have respective first and second fields of view. The intersection of the field of illumination and the first field of view forms a first overlap region. The intersection of the field of illumination and the second field of view forms a second overlap region. When a surface is within one or both of the first and second overlap region, the surface reflects light from the light source to the respective light sensor. The controller is configured to determine a first distance measurement to a surface within one or both of the first and second overlap regions based on the ratio of reflected light from the light source received by the first sensor and reflected light from the light source received by the second sensor. A similar ultrasonic sensor is also disclosed.

### CROSS-REFERENCE TO RELATED APPLICATIONS

The present application is the national stage entry of International Pat. Application No. PCT/SG2021/050799, filed on Dec. 17, 2021, and published as WO 2022/169410A1 on Aug. 11, 2022, which claims the benefit of priority of Great Britain Application No. 2101612.6, filed on Feb. 5, 2021, all of which are incorporated by reference herein in their entireties.

### FIELD OF THE INVENTION

The present invention relates to optical or ultrasonic sensors, particularly for the measurement of distance.

### BACKGROUND

Optical proximity sensors measure the amount of light reflected from an object to determine whether an object is within a specified region. A simple proximity sensor as shown in FIG. 1 comprises a light source 101 and a light sensor 102, with the field of illumination 111 of the light source overlapping the field of view 112 of the light sensor. An object 103 having a surface within the overlap region 113 will cause light 114 to be reflected back to the light sensor, providing a measurable signal.

In general, when an object is closer to the sensor, it will produce a stronger signal. However the strength of the signal also depends on the reflectance of the object and its orientation (e.g. whether the sensor is receiving diffuse or specular reflection), so this simple sensor cannot be used to determine the position of an object within the overlap region 113 to any useful degree of accuracy.

Multiple such sensors may be combined to gain coarse distance information, e.g. as disclosed in US 8,862,271 B2, and illustrated in FIG. 2. The system shown comprises a single light sensor 201 with a field of view 211 and two light sources 202, 203, with respective fields of illumination 212, 213. The light sensor and light sources are arranged such that the region of overlap 221 between the first field of illumination and the sensor’s field of view is not the same as the region of overlap 222 between the second field of illumination and the sensor’s field of view. By having the light sources emit at different frequencies, or pulsing them at different times, or similar means, the system can determine whether a surface is present in the first overlap 221 or the second overlap 222, giving a very coarse distance estimate (i.e. whether the surface is within a distance range D1 corresponding to the first overlap, or a distance range D2 corresponding to the second overlap). This system is in principle scalable to any number of overlap regions (by providing suitably arranged sensors and light sources), but achieving fine-grained accuracy would require an impractical number of components.

More complex sensors can determine accurate distances for any object (provided it reflects at least some light back to the sensor) via a “time of flight” mechanism, i.e. measuring the time difference between a pulse emitted by the light source and that pulse being received by the light sensor. However, such systems are electronically complex and tend to consume significantly more power than the simpler devices described above.

There is therefore a need for an optical proximity sensor with an ability to measure distance accurately, but without the complexity involved in a time-of-flight sensor.

### SUMMARY

According to a first aspect of the invention, there is provided an optical sensor. The optical sensor comprises a light source, first and second light sensors, and a controller. The light source has a field of illumination. The first and second light sensors have respective first and second fields of view. The intersection of the field of illumination and the first field of view forms a first overlap region. The intersection of the field of illumination and the second field of view forms a second overlap region. When a surface is within one or both of the first and second overlap regions, the surface reflects light from the light source to the respective light sensor. The controller is configured to determine a first distance measurement to a surface within one or both of the first and second overlap regions based on the ratio of reflected light from the light source received by the first sensor and reflected light from the light source received by the second sensor.

The controller may be further configured to:
apply modulation to the light source;
determine a second distance measurement to the surface based on time of flight of reflected light from the light source to the first sensor;
output the first distance measurement if at least one of the first or second distance measurements is below a threshold distance, and the second distance measurement if at least one of the first or second distance measurements are above a threshold distance.

According to a second aspect, there is provided an optical sensor assembly. The optical sensor assembly comprises an optical sensor according to the first aspect and an optical time of flight sensor. The optical time of flight sensor comprises a third light sensor, a further light source, and a time of flight system configured to determine a second distance measurement to the surface based on time of flight of light emitted by the further light source, reflected by the object, and received by the third light sensor. The controller of the first aspect is further configured to output the first distance measurement if at least one of the first or second distance measurements is below a threshold distance, and the second distance measurement if at least one of the first or second distance measurements are above a threshold distance.

According to a third aspect, there is provided a method of operating an optical sensor according to the first aspect. The method comprises determining a distance to a surface within one or both of the first and second overlap regions based on the ratio of reflected light from the light source received by the first sensor and reflected light from the light source received by the second sensor.

According to a fourth aspect of the invention, there is provided an ultrasonic sensor. The ultrasonic sensor comprises a ultrasound source, first and second ultrasound sensors, and a controller. The ultrasound source has a target field. The first and second ultrasound sensors have respective first and second fields of view. The intersection of the target field and the first field of view forms a first overlap region. The intersection of the target field and the second field of view forms a second overlap region. When a surface is within one or both of the first and second overlap regions, the surface reflects ultrasound from the ultrasound source to the respective ultrasound sensor. The controller is configured to determine a first distance measurement to a surface within one or both of the first and second overlap regions based on the ratio of reflected ultrasound from the ultrasound source received by the first sensor and reflected ultrasound from the ultrasound source received by the second sensor.

According to a fifth aspect, there is provided a method of operating an ultrasonic sensor according to the first aspect. The method comprises determining a distance to a surface within one or both of the first and second overlap regions based on the ratio of reflected ultrasound from the ultrasound source received by the first sensor and reflected ultrasound from the ultrasound source received by the second sensor.

### BRIEF DESCRIPTION OF THE DRAWINGS

FIG. 1 shows a simple optical proximity sensor according to the prior art;

FIG. 2 shows a further optical proximity sensor according to the prior art;

FIG. 3 shows an exemplary optical sensor;

FIG. 4 shows a further exemplary optical sensor;

FIG. 5 shows an exemplary optical sensor system incorporating an optical sensor such as that in FIG. 3, and a time-of-flight optical distance sensor;

FIG. 6 shows a yet further exemplary optical sensor; and

FIG. 7 shows an exemplary ultrasonic sensor.

### DETAILED DESCRIPTION

FIG. 3 shows an example optical sensor as will be described in more detail below. The optical sensor comprises first and second light sensors 301, 302, and a light source 303. The light sensors and the light source are arranged such that the field of view 311 of the first light sensor overlaps the field of illumination 313 of the light source in a first overlap region 321, and the field of view 312 of the second light sensor overlaps the field of illumination 313 of the light source in a second overlap region 322. In the case shown in FIG. 3, the first overlap region is a strict subset of the second overlap region, but this is not necessarily the case - there will be a region where the first overlap region intersects with the second overlap region, but the first overlap region may have subregions outside of the second overlap region and vice versa.

An object 304 with a surface which is within both overlap regions will result in a signal R₁ at the first sensor, and a signal R₂ at the second sensor. Each of R₁ and R₂ will depend mainly on the area of the surface within each region, the reflectance of the surface, and the intensity of the light source. The ratio R₁/R₂ (and its inverse) will not depend on the reflectance of the surface or other surface properties (assuming it is uniform, which is a good approximation in most cases for small areas), as this will cancel out. As such, this ratio (or its inverse) can be used (with suitable calibration) to determine the distance between the optical sensor and the surface.

While FIG. 3 shows the field of illumination and each field of view as a conical region in the same orientation, this need not be the case. The field of illumination and fields of view may be of any shape, as determined by the light sources and light sensors used and any other optical components such as lenses or apertures, and they may be oriented in any suitable way to achieve the required overlap regions (as described in more detail later).

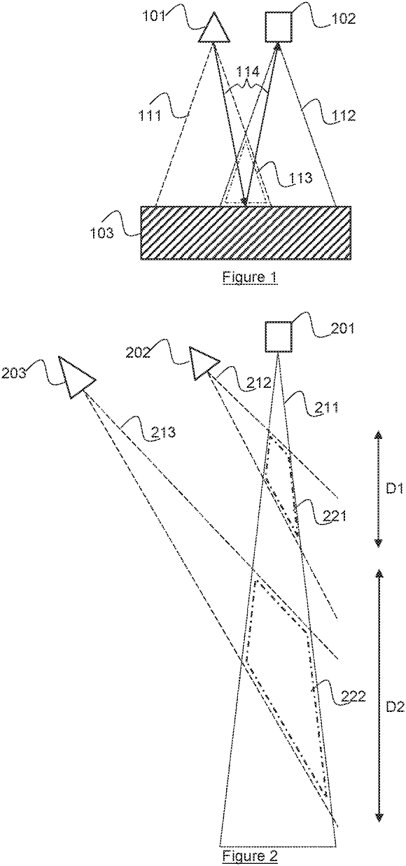

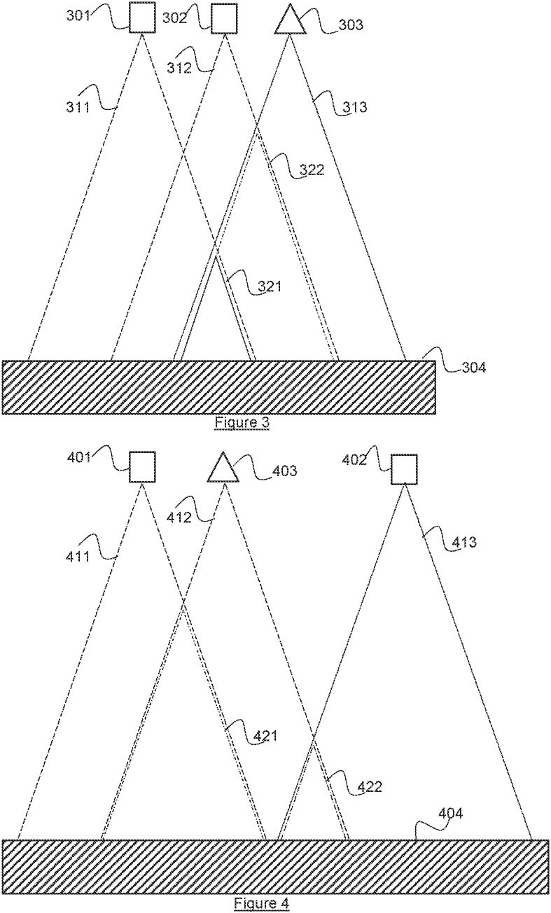

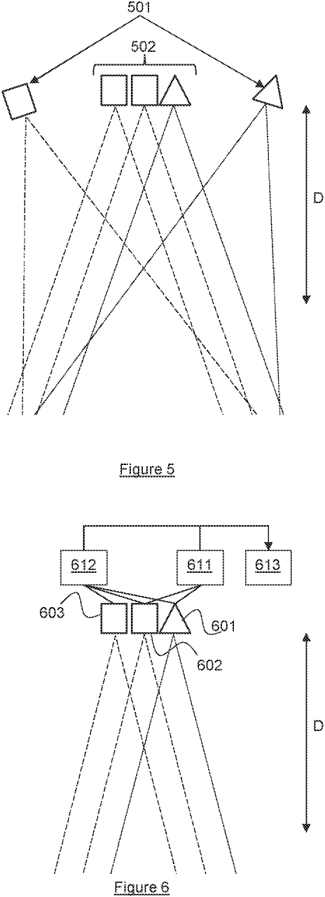

FIG. 4 shows an alternative example where the overlap regions do not have an intersection between the sensor and the object being detected (though they would intersect beyond the object). Reference numerals are equivalent to those of FIG. 3, unless stated. The overlap region 421 between the first field of view 411 and the field of illumination 412 does not intersect with the overlap region 422 between the second field of view 412 and the field of illumination. However, the same principle as described in FIG. 3 will still work here - by taking the ratio of the signals R₁ and R₂ from the respective sensors, a value can be obtained from which the distance to the object 404 may be derived (via suitable calibration).

The orientation of the light sources and light sensor may be chosen in any reasonable orientation such that a) there is a respective overlap region which is the intersection of the field of view of each light sensor and the field of illumination of the light source, and b) there is a range of distance from the light sensor in which both overlap regions are present. Within that range of distance, the optical sensor will be able to determine the distance to a surface based on the ratio R₁/R₂ of the reflected light received at each sensor. Outside of that distance, where R₁ is 0 and R₂ is non-zero (i.e. the ratio is zero), the sensor will be able to determine that the surface is within a distance range where the second overlap region is present, but not the first overlap region. Similarly, where R₂ is zero and R₁ is non-zero (i.e. the ratio is infinite), the surface is within a region where the first overlap region is present, but not the second. Where both R₁ and R₂ are zero (i.e. the ratio is indeterminate), then no surface is present in either overlap region.

The light source should also not be in the field of view of any of the light sensors - i.e. the sensors should only receive light from the light source via reflection from an object within the overlap region(s).

The light sources and sensors may emit and detect light of any suitable wavelength (or range or combination of wavelengths) provided the light sensor is sensitive to at least a part of the light emitted by the light sources. Modulation of the light emitted by the light source, e.g. pulsing the light source, may be used to allow the signal to be differentiated from ambient light, for example by taking a reading from each sensor with the light source off, and subtracting that reading from signals received by the sensors when the light source is on.

The device described above may in principle be built at any scale. Accuracy is improved at smaller scales, as the use of the ratio R₁/R₂ to determine distance relies in part on relative uniformity of reflectance across the surface. As such, particular applications of this device include close-range distance measurement, e.g. an optical sensor as described above may be included on earbuds, to detect how far they have been inserted into the ear (allowing audio output to be adjusted to ensure the best listening experience), or on wearable electronics to differentiate between the device being worn and the device being in a charging dock or similar. Such close range applications are particularly problematic for existing time-of-flight sensors, which struggle to accurately measure distances of less than 20 mm (whereas the device as described above in principle has no minimum distance, given suitable alignment of the sensors and the light source). Longer range applications include for robot vacuums or other autonomous mobile devices within a building, for the detection of steps and other “cliffs”. The use of one or more such sensors may also be used to implement “gesture” control of a device, e.g. activating a function if a surface (such as a hand) is waved at a particular distance from the sensor, or with a particular pattern of movement.

The device described above is particularly useful at distances less than 100 mm, as the optics required to ensure a narrow field of view and field of illumination beyond this distance are complex, which reduces the advantage of this device over a time-of-flight based mechanism. Given this, and given that time of flight sensors are unreliable at short distances (e.g. less than 50 mm), a combined sensor may be used which comprises both an optical distance sensor as described above, and a time of flight sensor.

In one example, as shown in FIG. 5 a first set of a light source and a sensor may be used by the time of flight sensor 501, and a second set of a light source and two sensors may be used by the optical distance sensor 502 as described above. The sensors of the optical distance sensor are arranged such that both overlap regions of the optical distance sensor cover the desired sensing region to at least a first distance D, and the sensor and light source of the time of flight sensor are arranged such that the overlap between their field of view and field of illumination covers the desired sensing region at least beyond the distance D. A controller (not shown) receives signals from all sensors, and if the time of flight sensor 501 indicates a distance to an object of less than D (or does not return a usable reading), then the controller uses the readings from the optical distance sensor 502. Alternatively or additionally, the controller may be configured to check the reading of the optical distance sensor 502, and to use the distance measurement from the time of flight sensor 501 if the optical distance sensor 502 indicates a distance greater than D, or does not return a usable reading. In either case, the effect is that the controller determines the distance based on a signal from the optical distance sensor 502 for distances less than D, and from the time of flight sensor for distances greater than D (up to the maximum range of the time of flight sensor). While FIG. 5 shows the source and sensor for the time of flight sensor 501 either side of the source and sensors for the optical distance sensor 502, these may be in any suitable arrangement.

In a second example as shown in FIG. 6, a single set of light source(s) 601 and sensors 602, 603 is shared by the time of flight sensor 611 and the optical distance sensor as described above 612. For example, the time of flight sensor 611 may determine distance from the signal received by the sensor 602 due to light reflected from the light source 601, and may control the light source to apply appropriate modulation to enable time-of-flight distance measurement. At the same time, the optical distance sensor 612 may determine distance from the signal received from the sensors 602 and 603, due to light reflected from the light source 601, with appropriate corrections to account for any modulation performed by the time of flight sensor. As previously, controller 613 determines the final distance measurement by using the result from the optical distance sensor below a specified distance threshold, and from the time of flight sensor above that threshold.

Where the above has referred to a “controller”, this may be implemented as any suitable combination of hardware and software, e.g. an ASIC, a general purpose processor running code adapted to perform the required functions, or similar. The controller need not be a single device, and may comprise an array of cooperating devices, or an array of individual processors. memory elements, etc. within a device. Where control functions are ascribed to other elements (e.g. to the time of flight sensor 611), this is for ease of understanding of the overall method, and these control functions may be integrated into the controller, or such other elements as perform those functions may be considered a part of the “controller”.

While the above has described a system with two sensors, further sensors may be used, with the ratio of different pairs of the sensors being used either to validate distance measurements, or to provide improved sensitivity at different distances.

Where the above description refers to “light”, this should be taken to include visible light, infra-red, and ultra-violet.

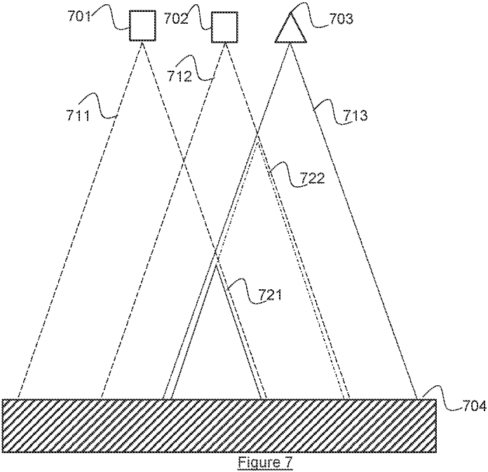

A similar system may be used with ultrasound, rather than light, as illustrated in FIG. 7. The ultrasound sensor comprises first and second ultrasound sensors 701, 702, and a ultrasound source 703. The ultrasound sensors and the ultrasound source are arranged such that the field of view 711 of the first ultrasound sensor overlaps the target field 713 of the ultrasound source in a first overlap region 721, and the field of view 712 of the second ultrasound sensor overlaps the target field 713 of the ultrasound source in a second overlap region 722. In the case shown in FIG. 7, the first overlap region is a strict subset of the second overlap region, but this is not necessarily the case - there will be a region where the first overlap region intersects with the second overlap region, but the first overlap region may have subregions outside of the second overlap region and vice versa.

The “target field” of the ultrasound means the volume exposed to the ultrasound in the absence of any reflecting surfaces other than those of the ultrasound distance sensor itself - i.e. the equivalent to the field of illumination of the light sources in FIG. 3.

An object 704 with a surface which is within both overlap regions will result in a signal R₁ at the first sensor, and a signal R₂ at the second sensor. Each of R₁ and R₂ will depend mainly on the area of the surface within each region, the reflectance of the surface, and the intensity of the ultrasound source. The ratio R₁/R₂ (and its inverse) will not depend on the reflectance of the surface or other surface properties (assuming it is uniform, which is a good approximation in most cases for small areas), as this will cancel out. As such, this ratio (or its inverse) can be used (with suitable calibration) to determine the distance between the optical sensor and the surface.

All of the specific examples described above for the optical sensor also apply to the ultrasonic sensor - e.g. the target fields and fields of view of the senor may be any suitable shape or alignment, and multiple ultrasound sources may be used. Similarly to the optical sensor, the ultrasonic sensor may be combined with an ultrasonic time of flight sensor, with a distance threshold determining which sensor is used to provide the final reading.

1. An optical sensor comprising:
a light source having a field of illumination;
first and second light sensors having respective first and second fields of view; wherein:
the intersection of the field of illumination and the first field of view forms a first overlap region;
the intersection of the field of illumination and the second field of view forms a second overlap region;
such that when a surface is within one or both of the first and second overlap regions, the surface reflects light from the light source to the respective light sensor;
a controller configured to determine a first distance measurement to a surface within one or both of the first and second overlap regions based on the ratio of reflected light from the light source received by the first sensor and reflected light from the light source received by the second sensor.

2. The optical sensor according to claim 1, wherein the first overlap region is a subset of the second overlap region, or the second overlap region is a subset of the first overlap region.

3. The optical sensor according to claim 1, wherein the first overlap region has a subregion which is outside the second overlap region, and the second overlap region has a subregion which is outside the first overlap region.

4. The optical sensor according to claim 1, wherein the controller is further configured to:
apply modulation to the light source;
determine a second distance measurement to the surface based on time of flight of reflected light from the light source to the first sensor;
output the first distance measurement if at least one of the first or second distance measurements is below a threshold distance, and the second distance measurement if at least one of the first or second distance measurements are above a threshold distance.

5. The optical sensor according to claim 4, wherein the threshold distance is between 50 mm and 100 mm.

6. An optical sensor array comprising:
an optical sensor according to claim 1;
an optical time of flight sensor comprising a third light sensor, a further light source, and a time of flight system configured to determine a second distance measurement to the surface based on time of flight of light emitted by the further light source, reflected by the object, and received by the third light sensor;
wherein the controller is configured to output the first distance measurement if at least one of the first or second distance measurements is below a threshold distance, and the second distance measurement if at least one of the first or second distance measurements are above a threshold distance.

7. The optical sensor according to claim 6, wherein the threshold distance is between 50 mm and 100 mm.

8. A method of operating an optical sensor, the optical sensor comprising:
a light source having a field of illumination;
first and second light sensors having respective first and second fields of view; wherein:
the intersection of the field of illumination and the first field of view forms a first overlap region;
the intersection of the field of illumination and the second field of view forms a second overlap region;
such that when a surface is within the first and/or second overlap region, the surface reflects light from the light source to the respective light sensor;
the method comprising determining a distance to a surface within one or both of the first and second overlap regions based on the ratio of reflected light from the light source received by the first sensor and reflected light from the light source received by the second sensor.

9. An ultrasonic sensor comprising:
an ultrasound source having a target field which is the volume exposed to the ultrasound from the source;
first and second ultrasound sensors having respective first and second fields of view; wherein:
the intersection of the target field and the first field of view forms a first overlap region;
the intersection of the target field and the second field of view forms a second overlap region;
such that when a surface is within one or both of the first and second overlap region, the surface reflects ultrasound from the ultrasound source to the respective ultrasound sensor;
a controller configured to determine a first distance measurement to a surface within one or both of the first and second overlap regions based on the ratio of reflected ultrasound from the ultrasound source received by the first sensor and reflected ultrasound from the ultrasound source received by the second sensor.

10. The ultrasonic sensor according to claim 9, wherein the first overlap region is a subset of the second overlap region, or the second overlap region is a subset of the first overlap region.

11. The ultrasonic sensor according to claim 9, wherein the first overlap region has a subregion which is outside the second overlap region, and the second overlap region has a subregion which is outside the first overlap region.

12. A method of operating an ultrasonic sensor, the ultrasonic sensor comprising:
an ultrasound source having a target field which is the volume exposed to the ultrasound from the source;
first and second ultrasound sensors having respective first and second fields of view; wherein:
the intersection of the target field and the first field of view forms a first overlap region;
the intersection of the target field and the second field of view forms a second overlap region;
such that when a surface is within the first and/or second overlap region, the surface reflects ultrasound from the ultrasound source to the respective ultrasound sensor;
the method comprising determining a distance to a surface within one or both of the first and second overlap regions based on the ratio of reflected ultrasound from the ultrasound source received by the first sensor and reflected ultrasound from the ultrasound source received by the second sensor.
